(19) United States
(12) Patent Application Publication
(10) Pub. No.: US 2015/0321497 A1
(43) Pub. Date: Nov. 12, 2015

(54) METHOD OF PREPARING A FLEXOGRAPHIC PRINTING MASTER

(71) Applicant: AGFA GRAPHICS NV, Mortsel (BE)

(72) Inventors: Stefaan LINGIER, Mortsel (BE); Werner MEURIS, Mortsel (BE)

(73) Assignee: Agfa Graphics NV, Mortsel (BE)

(21) Appl. No.: 14/650,925

(22) PCT Filed: Dec. 4, 2013
(86) PCT No.: PCT/EP2013/075447

§ 371 Date: Jun. 10, 2015

Related U.S. Application Data
(60) Provisional application No. 61/748,139, filed on Jan. 2, 2013.

(30) Foreign Application Priority Data
Dec. 18, 2012 (EP) 12197710.2

(51) Int. Cl. B41N 3/00

(52) U.S. Cl. CPC B41N 3/00

(57) ABSTRACT

A method for preparing a flexographic printing master on a sleeve includes using a reusable sleeve. The reusable sleeve includes a self adhesive on its outer surface. In a first preferred embodiment, a support is removably attached to the reusable sleeve after which a relief image is formed on the support by an inkjet method. In a second preferred embodiment, a Direct Laser Engraving (DLE) flexographic printing master precursor is removably attached to the reusable sleeve, after which a relief image is formed by DLE. The flexographic printing masters can then be removed from the sleeve after printing, and the sleeve can be reused to make new printing masters.

### CROSS-REFERENCE TO RELATED APPLICATIONS

This application is a 371 National Stage Application of PCT/EP2013/075447, filed Dec. 4, 2013. This application claims the benefit of U.S. Provisional Application No. 61/748,139, filed Jan. 2, 2013, which is incorporated by reference herein in its entirety. In addition, this application claims the benefit of European Application No. 12197710.2, filed Dec. 18, 2012, which is also incorporated by reference herein in its entirety.

### BACKGROUND OF THE INVENTION

1. Field of the Invention

The present invention relates to a method for making a flexographic printing master.

2. Description of the Related Art

Flexography is a printing process which utilizes a flexible relief plate, the flexographic printing master. It is basically an updated version of letterpress that can be used for printing on almost any type of substrate including plastic, metallic films, cellophane, and paper. Flexography is widely used for printing on packaging material, for example food packaging, and for printing continuous patterns, such as for gift wrap and wall paper.

Today flexographic printing masters are prepared by both analogue and digital imaging techniques. Analogue imaging typically uses a film mask through which a flexographic printing precursor is exposed. Digital imaging techniques include:
Direct laser engraving as disclosed in e.g. EP-As 1710093 and 1936438;
UV exposure through a LAMS mask wherein LAMS stands for Laser Ablative Mask System as disclosed in e.g. EP-A 1170121;
Direct UV or violet exposure by laser or LED as disclosed in e.g. U.S. Pat. No. 6,806,018; and
Inkjet printing as disclosed in e.g. EP-As 1428666 and 1637322.

The major advantage of an inkjet method for preparing a flexographic printing master is an improved sustainability due to the absence of any processing step and the consumption of no more material as necessary to form a suitable relief image (i.e. removal of material in the non printing areas is no longer required).

EP-A 641648 discloses a method of making a photopolymer relief-type printing plate wherein a positive or negative image is formed on a substrate by inkjet printing and curing a photopolymeric ink.

EP-A 1428666 discloses a method of making a flexographic printing master by means of jetting subsequent layers of a curable fluid on a flexographic support. Before jetting the following layer, the previous layer is immobilized by a curing step.

In U.S. Pat. No. 7,036,430 a flexographic printing master is prepared by inkjet wherein each layer of ink is first jetted and partially cured on a blanket whereupon each such layer is then transferred to a substrate having an elastomeric floor, thereby building up the relief image layer by layer. A similar method is disclosed in EP-A 1449648 wherein a lithographic printing plate is used to transfer such layers of ink to a substrate.

US2008/0053326 discloses a method of making a flexographic printing master by inkjet wherein successive layers of a polymer are applied to a specific optimized substrate. In US2009/0197013, also disclosing an inkjet method of making a flexographic printing master, curing means are provided to additionally cure, for example, the side surfaces of the image relief being formed. In EP-A 2223803 a UV curable hot melt ink is used. Each of the deposited layers of ink is gelled before a subsequent layer is deposited. After a printing master with sufficient thickness is formed, a curing step is carried out.

Two forms of flexographic printing supports are typically used, a sheet form and a cylindrical form, the latter commonly referred to as a sleeve. If the flexographic printing master is created as a sheet form, for example on a flatbed inkjet device, mounting the sheet form on a print cylinder may introduce mechanical distortions resulting in so-called anamorphic distortion in the printed image. Such a distortion may be compensated by an anamorphic pre-compensation in an image processing step prior to halftoning. Creating the flexographic printing master directly on a sheet form already mounted on a print cylinder or directly on a sleeve avoids the problem of geometric distortion altogether.

Moreover, creating the flexographic printing master directly on a sleeve provides improved registration accuracy on press since the image selections can be positioned with respect to a fixed point, e.g. the notch.

Another advantage of using a sleeve is the reduced mounting time, no need to use a mounting tape, and less space required if the print jobs have to be repeated.

A disadvantage however of using a sleeve as support is the cost price of a sleeve and space required for storage if print jobs have to be repeated,

A flexographic printing master formed on a support by an inkjet method typically comprises an elastomeric floor, an optional mesa relief and an image relief as disclosed in EP-A 2199082.

The elastomeric floor provides the necessary resilience to the printing master. A disadvantage however of forming such an elastomeric floor by inkjet may be throughput, i.e. the time necessary to form a flexographic printing master, and, depending on the cost price of the curable fluid with which the elastomeric floor is formed, the cost price of the printing master. In addition, applying a floor prevents the re-usage of the sleeve since once the relief layer is jetted and cured, this layer can not be removed easily.

It would therefore be advantageous to provide a method of making a flexographic printing master by inkjet printing wherein the sleeve may be reused and wherein no elastomeric floor has to be formed during the image formation.

### SUMMARY OF THE INVENTION

Preferred embodiments of the invention provide a method of preparing a flexographic printing master on a sleeve by inkjet printing wherein the sleeve may be reused and wherein no elastomeric floor has to be formed.

Additional preferred embodiments of the invention provide a method of preparing a flexographic printing master on a sleeve by Direct Laser Engraving (DLE) wherein the sleeve may be reused.

Further advantages and benefits of the invention will become apparent from the description hereinafter.

### BRIEF DESCRIPTION OF THE DRAWINGS

FIG. 1 is a schematic, cross sectional view of a reusable sleeve used in a method for preparing a flexographic printing master according to a preferred embodiment of the present invention.

FIG. 2 is a schematic representation of a flexographic printing master formed according to a first preferred embodiment of the invention.

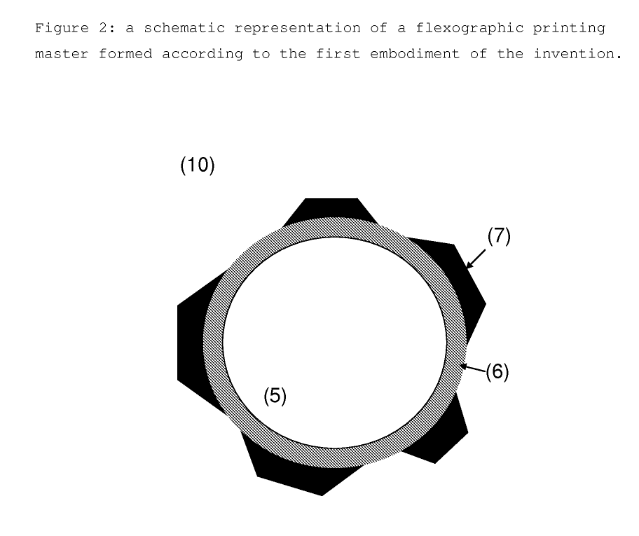

FIG. 3 is a schematic representation of a flexographic printing master formed according to a second preferred embodiment of the invention.

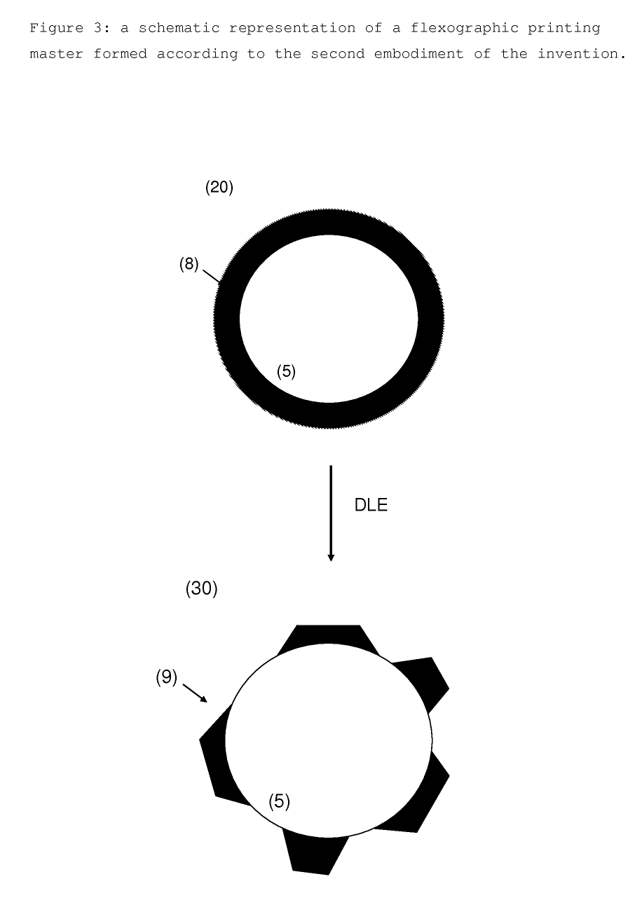

FIG. 4 is a schematic representation of a preferred embodiment of a drum based printing device that can be used in the first preferred embodiment of the present invention.

### DETAILED DESCRIPTION OF THE PREFERRED EMBODIMENTS

### Definitions

A FLEXOGRAPHIC PRINTING MASTER is used to print an image on a substrate and thus comprises a relief image. The relief image is formed by inkjet in the first preferred embodiment of the invention and by Direct Laser Engraving (DLE) in the second preferred embodiment of the invention.

A FLEXOGRAPHIC PRINTING MASTER PRECURSOR is used to make a flexographic printing master. The precursor does not have a relief image. The printing master precursor is converted to a printing master, i.e. a relief image is formed, by DLE in the second preferred embodiment of the invention. Such a precursor is referred to as a DLE flexographic printing master precursor.

REMOVABLY ATTACHING means that for example the support which is attached to the sleeve, may be easily (manually) removed from the sleeve without any damage to the sleeve or the support.

SELF ADHESIVE means that for example the support may be adhered to the sleeve by exercising pressure on the support.

A first preferred embodiment of the method for preparing a flexographic printing master according to the present invention comprises the steps of:

providing a sleeve, the sleeve comprising a resilient layer and on its outer surface a self adhesive for removably attaching a support;

providing a support on the self adhesive; and

forming a flexographic printing master by applying and curing a curable fluid on the support.

A second preferred embodiment of the method for preparing a flexographic printing master according to the present invention comprises the steps of:

providing a sleeve, the sleeve comprising a resilient layer and on its outer surface a self adhesive for removably attaching a DLE flexographic printing master precursor;

providing the DLE flexographic printing master precursor on the self adhesive;

forming a flexographic printing master by Direct Laser Engraving (DLE).

### Sleeve

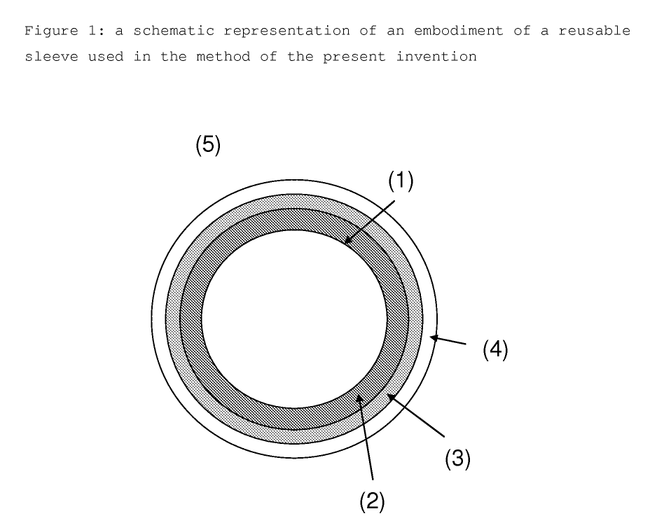

The reusable sleeve used in a preferred embodiment of the present invention comprises a resilient layer and on its outer surface a self adhesive for removably attaching a support or a DLE flexographic printing master precursor. A preferred embodiment of a reusable sleeve is schematically shown in FIG. 1. Such a sleeve (5) comprises in this order a basic sleeve (1), a resilient layer (2), a dimensionally stable supporting layer (3) and a self adhesive (4) for removably attaching a support or a DLE flexographic printing master precursor.

Flexographic printing masters may be removably attached to a sleeve by double-sided adhesive tapes. US2003/0037687 and U.S. Pat. No. 6,085,653 disclose a sleeve having on its outer surface a bonding self adhesive material that permits removable fixation of flexographic printing masters by adhesion. After fixing the flexographic print masters on the sleeve, followed by printing, the used masters may be removed from the sleeve and stored for later use. The sleeve may then be used as support for new flexographic printing masters. In the method described in US2003/0037687 and U.S. Pat. No. 6,085,653, the flexographic printing masters are first prepared before fixing them on the sleeve. If the printing master is created as a sheet form, mounting the sheet form on the sleeve may introduce mechanical distortions resulting in so-called anamorphic distortion in the printed image. In addition, the registration accuracy when mounting sheet forms on a sleeve may be insufficient.

Creating the flexographic printing master directly on a sleeve avoids the problem of geometric distortion and improves registration accuracy.

### Self Adhesive

The self adhesive as disclosed in the above mentioned US2003/0037687 may be used. In US2003/0037687 the self adhesive is a crosslinked polymer, coated or sprayed on a sleeve body. The polymers that may be used are for example polymers based on carboxylated nitrile, polyisoprene, acrylate resin, silicone, polychloroprene, ethylene vinyl acetate, butyl rubber and polyurethane. Crosslinking may be achieved by exposure to UV light or by the application by heat.

U.S. Pat. No. 6,079,329 also discloses a self adhesive, based on UV and thermal curable polymers. Examples of such polymers are disclosed on col. 3, ln. 45-60. WO2010/090685 also discloses a self adhesive layer applied on a print cylinder based on a UV curable composition comprising a binder, at least one monomer, a photo-initiator and microspheres.

Before the support or the DLE flexographic printing master precursor is removably attached, the surface of the self adhesive is preferably cleaned with a suitable solvent. In U.S. Pat. No. 6,079,329 suitable solvents are ethyl acetate, alcohol, and naphtha. However, according to U.S. Pat. No. 607932 any solvent volatile solvent which is compatible with the material of the self adhesive may be used.

### Dimensionally Stable Supporting Layer

The self adhesive layer is preferably applied on a dimensionally stable supporting layer. In addition, the flexibility of the support must be such that it can be easily fixed around the cylindrical sleeve.

Preferably, a polymeric supporting layer is used, most preferably a PET supporting layer is used.

The thickness of the supporting layer may be between 50 and 200 μm.

### Resilient Layer

The sleeve also comprises a resilient layer. The resilient layer is preferably provided between the basic sleeve and the dimensionally stable supporting layer.

The static compression of the resilient layer is preferably less than 12.5%, more preferably less than 11.5%, most preferably less than 8.5%. The creep recovery of the resilient layer is preferably at least 65%, more preferably at least 70%, most preferably at least 75%. The static compression referred is measured with a ball point probe (2.7 mm) where the sample is deformed for 5 minutes with a fixed pressure of 0.005 MPa.

The resilient layer is typically a polyurethane foam having different resilience properties.

### Basic Sleeve

Basic sleeves typically consist of composites, such as epoxy or polyester resins reinforced with glass fibre or carbon fibre mesh. Metals, such as steel, aluminium, copper and nickel, and hard polyurethane surfaces (e.g. durometer 75 Shore D) can also be used. The basic sleeve may be formed from a single layer or multiple layers of flexible material, as for example disclosed by US2002/466668. Flexible basic sleeves made of polymeric films can be transparent to ultraviolet radiation and thereby accommodate backflash exposure for building a floor in the cylindrical printing element. Multiple layered basic sleeves may include an adhesive layer or tape between the layers of flexible material. Preferred is a multiple layered basic sleeve as disclosed in U.S. Pat. No. 5,301,610. The basic sleeve may also be made of non-transparent, actinic radiation blocking materials, such as nickel or glass epoxy.

The reusable sleeve according to a preferred embodiment of the present invention thus preferably consists of, in this order, a basic sleeve, a resilient layer, a dimensionally stable supporting layer and a self adhesive, as shown in FIG. 1.

Such sleeves are commercially available as the “Twinlock™ self-adhesive Sleeves” from Polymount International BV.

In another preferred embodiment, the commercially available ChannalBAC™ (from Controlled Displacement Technologies LLC) double sided adhesive may also be used in a method according to the present invention. The double sided adhesive is provided on a basic sleeve (1) and a support (6) or a DLE flexographic printing master precursor (8) is attached on the adhesive. The ChannalBac™ adhesives also provide the necessary resilience and compressibility to the flexographic printing masters formed, in the same way as the resilient layer of the Twinlock™ system does.

In the first preferred embodiment of the invention, it has been observed that the presence of the resilient layer has as consequence that no elastomeric floor has to be printed on the support in order to obtain sufficient printing properties of the flexographic printing master, in contrast to for example the method disclosed in EP-A 2199082. The fact that printing such an elastomeric floor is not necessary in a method of the present invention, results in a substantially higher throughput and less consumption of fluid to make the floor.

### Support

The support (6) used in the first preferred embodiment of the present invention is preferably a dimensionally stable support. In addition, the flexibility of the support must be such that it can be easily fixed around the cylindrical sleeve.

Preferably, a polymeric support is used. Most preferably, a PET support is used.

The thickness of the support is preferably between 20 and 300 μm, more preferably between 50 and 250 μm, most preferably between 75 and 200 μm.

Preferably a primer is provided on that side of the support whereupon the relief image will be printed to improve the adhesion of that relief image to the support. Any primer may be used that improves the adhesion between the relief image and the support.

Preferred primers have as binder a sulfonated polyester, a polyester polyurethane or a copolymer of vinylidenechloride-methacrylic acid-itaconic acid.

### Method of Preparing the Flexographic Printing Master

A method for preparing a flexographic printing master according to the first preferred embodiment of the present invention comprises the steps of:

providing a sleeve (5), the sleeve comprising a resilient layer and on its outer surface a self adhesive for removably attaching a support;

providing a support (6) on the self adhesive; and

forming a relief image (7) on the support by applying and curing a curable fluid.

A method for preparing a flexographic printing master according to the second preferred embodiment of the present invention comprises the steps of:

providing a sleeve (5), the sleeve comprising a resilient layer and on its outer surface a self adhesive for removably attaching a DLE flexographic printing master precursor,

providing a DLE flexographic printing master precursor (8) on the self adhesive,

forming a relief image (9) by Direct Laser Engraving (DLE).

The sleeve described above is mounted on a cylindrical drum. Such a cylindrical drum is often referred to as a mandrel. The support or the DLE flexographic printing master precursor may be provided on the self adhesive of the sleeve before mounting it on the mandrel, or they may be provided on the self adhesive of the sleeve after mounting the sleeve. Preferably, an air mandrel is used. Air mandrels are hollow steel cores which can be pressurized with compressed air through a threaded inlet in the end plate wall. Small holes drilled in the cylindrical wall serve as air outlets. The introduction of air under high pressure permits to float the sleeve into position over an air cushion. Certain thin sleeves are also expanded slightly by the compressed air application, thereby facilitating the gliding movement of the sleeve over the roll core.

Preferably the mandrel is held in a cantilever construction at one side and fixed preferably with a tailstock, also known as a foot stock, at the other side.

Foamed adapter or bridge sleeves are used to “bridge” the difference in diameter between the air-cylinder and the sleeve. The diameter of a sleeve depends upon the required repeat length of the printing job.

The sleeve or bridge sleeve is loaded onto or unloaded from the mandrel by pressurized air. This pressurized air is applied to the inside of the mandrel preferably by a rotating joint.

Applying pressurized air will cause this air to flow through the air outlets of the mandrel. Once the sleeve covers these air outlets, the sleeve or bridge sleeve will expand, so it can be positioned over the mandrel against a reference preferably a pin. Removing this air pressure will cause the sleeve or bridge sleeve to shrink around the mandrel. The air pressure on/off is controlled by a valve which is controlled by a button in the inkjet printer, preferably from a graphical user interface which interacts with the inkjet printer.

In the first preferred embodiment of the invention, after mounting the sleeve described above on the mandrel, a support is removably attached to the sleeve. When the support is fixed on the sleeve, a flexographic relief image is then printed on the support by rotating the mandrel. The mandrel rotates at a fixed circumference speed of more than 0.5 m/s, preferably more than 1 m/s, more preferably more than 2 m/s.

The mandrel is able to hold sleeves or bridge sleeves of a length up to 1450 mm, preferably up to 2900 mm and sleeves or bridge sleeves with outer circumference, also known as repeat, from 300 mm up to 1000 mm, preferably from 75 mm up to 2000 mm.

Several methods of preparing a flexographic printing master by inkjet are disclosed in EP-As 1637322, 2199081, 2199082 and WOs 2008/077850 and 2011/144596 and may be used in a method according to this invention. In all those methods, subsequent layers of a curable fluid are jetted by an inkjet print head and subsequently at least partially cured.

A typical flexographic printing master prepared with inkjet is disclosed in EP-A 2199082. It typically comprises on a substrate, preferably a sleeve body, an elastomeric floor, an optional mesa relief and an image relief.

However, in a method of the present invention, preferably no floor is applied on the support. The flexographic relief image thus consists of an optional mesa relief and an image relief.

In the second preferred embodiment of the invention, after mounting the sleeve described above on the mandrel, a DLE flexographic printing master precursor is removably attached to the sleeve.

Then, a relief image is formed by Direct Laser Engraving (DLE). Such methods are known in the art. The DLE method disclosed in EP-A 2236290, paragraphs [0137] to [150] may be used to form the flexographic printing master. Other methods to form a flexographic printing master with DLA are disclosed in EP-A 1710094, US2011/277649, US2011/278767.

After the relief image is formed by DLE, an optional rinsing step may be carried out, preferably with water or a liquid containing water as a main component.

Suitable flexographic printing forms for laser engraving are disclosed in EP-As 1424210, 1710093, 1936438 and 2236290, in US2005/0227165 and US2010/248151.

When the flexographic relief image has been provided, printing may be started. Such a printing method according to the first preferred embodiment of the invention thus comprises the steps of:

providing a sleeve, the sleeve comprising a resilient layer and on its outer surface a self adhesive for removably attaching a support;

providing a support on the self adhesive;

forming a relief image on the support by applying and curing a curable fluid;

applying a flexographic ink to the relief image; and

transferring the ink from the relief image to a receiver material.

A printing method according to the second preferred embodiment of the invention thus comprises the steps of:

providing a sleeve, the sleeve comprising a resilient layer and on its outer surface a self adhesive for removably attaching a DLE flexographic printing master precursor for laser engraving;

providing a DLE flexographic printing master precursor on the self adhesive;

forming a relief image by Direct Laser Engraving (DLE);

optionally carrying out a cleaning step;

applying a flexographic ink to the relief image; and

transferring the ink from the relief image to a receiver material.

After printing, the support bearing the flexographic relief image, i.e the flexographic printing master according to the first preferred embodiment of the invention, or the flexographic printing master according to the second preferred embodiment of the invention, may be removed from the sleeve and stored for later use. The sleeve can then be used for preparing another flexographic printing master.

Before adhering another support, or DLE flexographic printing master precursor, the outer surface of the sleeve, i.e. the self adhesive, is preferably cleaned by a solvent as described above. A new flexographic relief image can then be provided using the aforementioned methods.

Another method for preparing a flexographic printing master according to the first preferred embodiment of the present invention thus comprises the steps of:

providing a sleeve, the sleeve comprising a resilient layer and on its outer surface a self adhesive for removably attaching a support;

providing a support on the self adhesive;

forming a flexographic relief image on the support by applying and curing a curable fluid;

applying a flexographic ink to the relief image;

transferring the ink from the relief image to a receiver material;

removing the support bearing the relief image from the sleeve;

optionally cleaning the outer surface of the sleeve;

providing a new support on the outer surface of the sleeve;

forming a new relief image on the new support by applying and curing a curable fluid;

applying ink to the new relief image; and

transferring the ink from the new relief image to a receiver material.

Another method for preparing a flexographic printing master according to the second preferred embodiment of the present invention thus comprises the steps of:

providing a sleeve, the sleeve comprising a resilient layer and on its outer surface a self adhesive for removably attaching a DLE flexographic printing master precursor;

providing a DLE flexographic printing master precursor on the self adhesive;

forming a flexographic relief image by Direct Laser Engraving (DLE);

optionally carrying out a cleaning step;

applying a flexographic ink to the relief image;

transferring the ink from the relief image to a receiver material;

removing the flexographic printing master;

optionally cleaning the outer surface of the self adhesive;

providing a new DLE flexographic printing master precursor for laser engraving on the self adhesive;

forming a new flexographic relief image by Direct Laser Engraving;

applying ink to the new relief image; and

transferring the ink from the new relief image to a receiver material.

Such methods have the advantage the a single expensive sleeve can be used to prepare multiple flexographic printing masters, resulting in a substantial cost price reduction.

### Curable Fluid

Typical ingredients are preferably selected from the group consisting of a monofunctional (meth)acrylate monomer, a difunctional (meth)acrylate monomer, a multifunctional (meth)acrylate monomer or oligomer, a low viscous monofunctional urethane acrylate oligomer (especially for curable inkjet fluid), a higher viscous mono- or multifunctional urethane acrylate (especially for the curable aerosol jet fluid), an initiator, a plasticizer, an inhibitor, an elastomeric binder, a surfactant, a colorant, a solvent, a humectant, a synergist, a biocide.

### Monofunctional (Meth)Acrylate Monomer

The curable fluid may comprise a monofunctional (meth)acrylate monomer. Any monofunctional (meth)acrylate monomer, such as disclosed for example in EP-A 1637322, paragraph [0055], may be used.

However, the curable fluid preferably comprises a cyclic monofuntional (meth)acrylate monomer. Examples of such cyclic monofunctional (meth)acrylates are isobornyl acrylate (SR506D from Sartomer), tetrahydrofurfuryl methacrylate (SR203 from Sartomer), 4-t.butylcyclohexyl arylate (Laromer TBCH from BASF), dicyclopentadienyl acrylate (Laromer DCPA from BASF), dioxalane functional acrylates (CHDOL10 and MEDOL10 from San Esters Corporation), cyclic trimethylolpropane formal acrylate (SR531 from Sartomer), 2-phenoxyethyl acrylate (SR339C from Sartomer), 2-phenoxyethyl methacrylate (SR340 from Sartomer), tetrahydrofurfuryl acrylate (SR285 from Sartomer), 3,3,5-trimethyl cyclohexyl acrylate (CD420 from Sartomer).

Particularly preferred cyclic monofunctional (meth)acrylates monomers are isobornyl acrylate (IBOA) and 4-t.butylcyclohexyl arylate (Laromer TBCH from BASF).

The amount of the cyclic monofunctional (meth)acrylate monomer is preferably at least 25 wt %, more preferably at least 30 wt %, relative to the total weight of the curable fluid.

### Difunctional (Meth)Acrylate Monomer

A preferred difunctional (meth)acrylate monomer is a polyalkylene glycol di(meth)acrylate. Such compounds have two acrylate or methacrylate groups attached by an ester linkage at the opposite ends of a hydrophilic polyalkylene glycol. Typically, the longer the length of the polyalkylene chain, the softer and more flexible the obtained layer after curing.

Examples of such polyalkylene glycol di(meth)acrylates include:

1,3-butylene glycol diacrylate, 1,3-butylene glycol dimethacrylate, diethylene glycol diacrylate, diethylene glycol dimethacrylate, dipropylene glycol diacrylate, ethylene glycol dimethacrylate, polyethylene glycol (200) diacrylate, polyethylene glycol (400) diacrylate, polyethylene glycol (400) dimethacrylate, polyethylene glycol (600) diacrylate, polyethylene glycol (600) dimethacrylate, polyethylene glycol dimethacrylate, polypropylene glycol (400) dimethacrylate, tetraethylene glycol diacrylate, tetraethylene glycol dimethacrylate, triethylene glycol diacrylate, triethylene glycol dimethacrylate, tripropylene glycol diacrylate, tripropylene glycol diacrylate, and combinations thereof. The number between brackets in the above list refers to the Molecular Weight (MW) of the polyalkylene chain.

Highly preferred polyalkylene glycol diacrylates are polyethylene glycol diacrylates. Specific examples of commercially available polyethylene glycol diacrylate monomers include SR259 [polyethylene glycol (200) diacrylate], SR344 [polyethylene glycol (400) diacrylate], SR603 [polyethylene glycol (400) dimethacrylate], SR610 [polyethylene glycol (600) diacrylate], SR252 [polyethylene glycol (600) dimethacrylate], all Sartomer products; EBECRYL 11 [poly ethylene glycol diacrylate from Cytec; Genomer 1251 [polyethylene glycol 400 diacrylate] from Rahn. Polyethylene glycol (600) diacrylate, available as SR610 from Sartomer, is particularly preferred.

Other preferred difunctional acrylate or methacrylate monomers are e.g. butane diol diacrylate, alkoxylated hexanediol diacrylate, alkoxylated neopentyl glycol diacrylate and alkoxylated hexanediol dimethacrylate.

The amount of the difunctional (meth)acrylate monomer is preferably at least 10 wt % of the total monomer content.

Particularly preferred difunctional (meth)acrylate monomers are those according to Formula I or II,

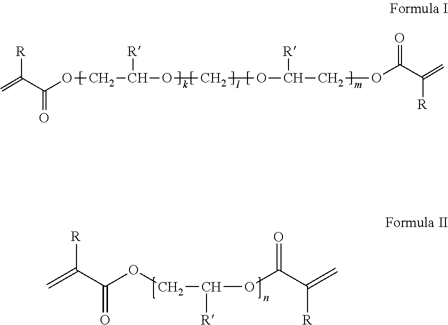

wherein

k and m in Formula I is an integer ranging from 0 to 5,

l in Formula I is an integer ranging from 1 to 20

n in Formula II is 1, 2, 3 or 4,

R is H or CH₃, and

R′ is H or an alkyl group.

Difunctional (meth)acrylate monomers according to Formula I are typically derived from diols containing an —(CH₂)— backbone.

Preferred compounds according to Formula I are polyoxytetramethylene diacrylate (Blemmer ADT250); 1,9 nonanediol diacrylate; 1,6 hexanediol diacrylate (SR238); 1,6 hexanediol dimethacrylate (SR239); 1,4 butanediol diacrylate (SR213); 1,2 ethanediol dimethacrylate (SR206); 1,4 butanediol dimethacrylate (SR214); ethoxylated 1,6 hexanediol diacrylate (Miramer M202)

Difunctional (meth)acrylate monomers according to Formula II are typically derived from diols containing a glycol ether backbone. The R′ group in Formula II is preferably H or methyl. Preferred compounds according to Formula II are dipropyleneglycol diacrylate (DPGDA, SR508), diethylene glycol diacrylate (SR230), triethyleneglycol diacrylate (SR272), 1,3-butylene glycol diacrylate, 1,3-butylene glycol dimethacrylate, diethylene glycol diacrylate, diethylene glycol dimethacrylate, dipropylene glycol diacrylate, ethylene glycol dimethacrylate, tetraethylene glycol diacrylate, tetraethylene glycol dimethacrylate, triethylene glycol diacrylate, triethylene glycol dimethacrylate, tripropylene glycol diacrylate, tripropylene glycol diacrylate, and combinations thereof.

The amount of the difunctional acrylate monomer according to Formula I or II is at least 1 wt %, preferably at least 5 wt %, more preferably at least 7.5 wt %, relative to the total weight of the curable fluid.

### Multi Functional (Meth)Acrylate Monomer

The curable fluid may further comprise a tri-, tetra- or penta-functional (meth)acrylate monomer. It has been observed that the hardness of the cured layer obtained from the curable fluid becomes too high when too much tri-, tetra- or penta-functional (meth)acrylate monomer is present in the fluid. The Shore A hardness of the cured layer must be kept below 80, to ensure good physical properties of the flexographic printing master. It has been observed that the maximum concentration of the tri-, tetra- or penta-functional (meth)acrylate monomer to ensure a proper hardness depends on their functionality. Typically, the higher their functionality, the lower their maximum allowable concentration to ensure a Shore A hardness below 80. In addition to its effect on the hardness, the functionality of the tri-, tetra- or penta-functional (meth)acrylate monomers also influences their viscosity, and thus also the viscosity of the curable fluid. Typically, the higher their functionality, the higher their viscosity. As the viscosity of the curable inkjet fluid, measured at jetting temperature, is preferably below 15 mPa·s, this also limits the maximum concentration of the tri- tetra- or penta-functional (meth)acrylate monomer in the jettable fluid.

Preferably, the maximum concentration of the tri-, tetra- or penta-functional (meth)acrylate monomer, dependent on their viscosity, is as depicted in the following table.

| | visco (mPa · s) | | | |
|---|---|---|---|---|
| functionality | <100 | 100-250 | 250-5000 | >5000 |
| 3 | 20 wt. % | 17.5 wt. % | 15 wt. % | 10 wt. % |
| 4 | 15 wt. % | 12.5 wt. % | 10 wt. % | 7.5 wt. % |
| 5 | 10 wt. % | 8 wt. % | 6 wt. % | 4 wt. % |

The minimum concentration is preferably 0.5 wt %, more preferably 1 wt %).

For the curable aerosol jet fluid, the higher viscosities are allowable as described above. Therefore, higher concentrations of multifunctional (meth)acrylate monomers may be used.

Preferred examples are ditrimethylol propane tetraacrylate (DTMPTA), glycerol triacrylate and their alkoxylated, i.e. ethoxylated or propoxylated, derivatives.

Specific compounds are trimethylol propane tetraacrylate (TMPTA), commercially available as Miramer M300; propoxylated TMPTA, commercially available as SR492; ethoxylated TMPTA, commercially available as Miramer M3130; DTMPTA, commercially available as SR355; propoxylated glyceryl triacrylate, commercially available as SR9021 and SR9020.

Other specific compounds are dipentaerythritol pentaacrylate (DIPEPA), commercially available as SR399LV; triacrylate esters of pentaerythritol, such as pentaerythritol triacrylate (PETIA); tetra-acrylate esters of pentaerythritol, such as PETRA, commercially available as SR295; ethoxylated PETRA, commercially available as SR494; alkoxylated PETRA, commercially available as Ebecryl 40.

### Urethane Acrylate Oligomer

The curable fluid may further contain monofunctional urethane acrylate oligomers.

Urethane acrylates oligomers are well known and are prepared by reacting polyisocyanates with hydroxyl alkyl acrylates, usually in the presence of a polyol compound. Their functionality (i.e. number of acrylate groups) varies from 1 to 6. A lower functionality results in lower reactivity, better flexibility and a lower viscosity. The polyol compound forms the backbone of the urethane acrylate. Typically the polyol compounds are polyether or polyester compounds with a functionality (hydroxyl groups) ranging from two to four. Polyether urethane acrylates are generally more flexible, provide lower cost, and have a slightly lower viscosity and are therefore preferred.

Commercially available urethane (meth)acrylates are e.g. CN9170, CN910A70, CN966H90, CN962, CN965, CN9290 and CN981 from SARTOMER; BR-3741B, BR-403, BR-7432, BR-7432G, BR-3042, BR-3071 from BOMAR SPECIALTIES CO.; NK Oligo U-15HA from SHIN-NAKAMURA CHEMICAL CO. Ltd.; Actilane 200, Actilane SP061, Actilane 276, Actilane SP063 from AKZO-NOBEL; Ebecryl 8462, Ebecryl 270, Ebecryl 8200, Ebecryl 285, Ebecryl 4858, Ebecryl 210, Ebecryl 220, Ebecryl 1039, Ebecryl 1259 and IRR160 from CYTEC; Genomer 1122 and Genomer 4215 from RAHN A.G. and VERBATIM HR50 an urethane acrylate containing liquid photopolymer from CHEMENCE.

The curable fluid preferably comprises monofunctional urethane acrylate oligomers, more preferably monofunctional aliphatic urethane acrylates, having a very low viscosity of 100 mPa·s or lower at 25° C., like for example Genomer 1122 (2-acrylic acid 2-{[(butylamino) carbonyl]oxy}ethyl ester, available from Rahn AG) and Ebecryl 1039 (available from Cytec Industries Inc.).

The total amount of the monofunctional urethane acrylate oligomer is preferably at least 5 wt %, more preferably at least 7.5 wt %, relative to the total weight of the curable fluid.

### Other Monomers or Oligomers

Additional mono- or multifunctional monomers or oligomers may be used to further optimize the properties of the curable fluid.

### Initiators

The curable fluid comprises an initiator which, upon exposure to radiation or heat, initiates the curing, i.e. polymerization, of the jetted droplets.

However, it is also possible to carry out the curing by electron beam radiation where the presence of an initiator is not mandatory.

Preferably a photo-initiator is used which upon absorption of actinic radiation, preferably UV-radiation, forms high-energy species (for example radicals) inducing polymerization and crosslinking of the monomers and oligomers of the jetted droplets.

A combination of two or more photo-initiators may be used. A photo-initiator system, comprising a photo-initiator and a co-initiator, may also be used. A suitable photo-initiator system comprises a photo-initiator, which upon absorption of actinic radiation forms free radicals by hydrogen abstraction or electron extraction from a second compound, the co-initiator. The co-initiator becomes the actual initiating free radical.

Irradiation with actinic radiation may be realized in two steps, each step using actinic radiation having a different wavelength and/or intensity. In such cases it is preferred to use 2 types of photo-initiators, chosen in function of the different actinic radiation used.

Suitable photo-initiators are disclosed in EP-A 1637926 paragraph [0077] to [0079].

To avoid extraction of the photo-initiator out of the flexographic printing master during printing, copolymerizable photo-initiators (and/or co-initiators) such as disclosed in WO2012/084811 may be used.

A preferred total amount of initiator is 1 to 10 wt %, more preferably 2.5 to 7.5 wt %, of the total curable fluid weight.

### Plasticizer

A plasticizer, as disclosed in for example EP-A 1637926 ([0085]-[0091]) may be added to the curable fluid. Such a plasticizer is typically a substance which, when added to a flexographic printing master, increases the softness and flexibility of that printing master. However, as mentioned above, such plasticizers may migrate to the surface of the relief image or may be extracted out of the relief image by the flexo printing ink during printing. For that reason, it is preferred to use a copolymerizable plasticizing monomer such as a low Tg monomer of which the corresponding homopolymer has a glass transition temperature below −15° C. or diallylphthalate, as disclosed in EP-A 2466380.

### Inhibitors

Suitable polymerization inhibitors include phenol type antioxidants, hindered amine light stabilizers, phosphor type antioxidants, hydroquinone monomethyl ether commonly used in (meth)acrylate monomers, and hydroquinone, methylhydroquinone, t-butylcatechol, pyrogallol may also be used. Of these, a phenol compound having a double bond in molecules derived from acrylic acid is particularly preferred due to its having a polymerization-restraining effect even when heated in a closed, oxygen-free environment. Suitable inhibitors are, for example, Sumilizer® GA-80, Sumilizer® GM and Sumilizer® GS produced by Sumitomo Chemical Co., Ltd.

Since excessive addition of these polymerization inhibitors will lower the sensitivity to curing of the curable jettable liquid, it is preferred that the amount capable of preventing polymerization be determined prior to blending. The amount of a polymerization inhibitor is generally between 200 and 20 000 ppm of the total curable fluid weight.

### Oxygen Inhibition

Suitable combinations of compounds which decrease oxygen polymerization inhibition with radical polymerization inhibitors are: 2-benzyl-2-dimethylamino-1-(4-morpholinophenyl)-butane-1 and 1-hydroxy-cyclohexyl-phenyl-ketone; 1-hydroxy-cyclohexyl-phenyl-ketone and benzophenone; 2-methyl-1-[4-(methylthio)phenyl]-2-morpholino-propane-1-on and diethylthioxanthone or isopropylthioxanthone; and benzophenone and acrylate derivatives having a tertiary amino group, and addition of tertiary amines. An amine compound is commonly employed to decrease an oxygen polymerization inhibition or to increase sensitivity. However, when an amine compound is used in combination with a high acid value compound, the storage stability at high temperature tends to be decreased. Therefore, specifically, the use of an amine compound with a high acid value compound in ink-jet printing should be avoided.

Synergist additives may be used to improve the curing quality and to diminish the influence of the oxygen inhibition. Such additives include, but are not limited to ACTILANE® 800 and ACTILANE® 725 available from AKZO NOBEL, Ebecryl® P115 and Ebecryl® 350 available from UCB CHEMICALS and CD 1012, Craynor CN 386 (amine modified acrylate) and Craynor CN 501 (amine modified ethoxylated trimethylolpropane triacrylate) available from CRAY VALLEY.

The content of the synergist additive is in the range of 0 to 20 wt %, preferably in the range of 5 to 15 wt %, based on the total weight of the curable fluid.

### Elastomeric Binder

The elastomeric binder may be a single binder or a mixture of various binders. The elastomeric binder is an elastomeric copolymer of a conjugated diene-type monomer and a polyene monomer having at least two non-conjugated double bonds, or an elastomeric copolymer of a conjugated diene-type monomer, a polyene monomer having at least two non-conjugated double bonds and a vinyl monomer copolymerizable with these monomers. Preferred elastomeric binders are disclosed in EP-A 1637926 paragraph [0092] and [0093].

Due to their high molecular weight, the addition of elastomeric binders may cause an increase in viscosity of the curable fluid. Therefore, the amount of elastomeric binder is preferably less than 5 wt % for the curable inkjet fluid. In a particular preferred embodiment, no elastomeric binder is added to the curable inkjet fluid. As viscosity is not an issue, more elastomeric binder, preferably more than 5 wt %, more preferably more than 10 wt %, may be used for the curable aerosol jet fluid.

### Surfactants

The surfactant(s) may be anionic, cationic, non-ionic, or zwitter-ionic and are usually added in a total amount below 20 wt %, more preferably in a total amount below 10 wt %, each based on the total curable fluid weight.

Fluorinated or silicone compounds are preferably used as a surfactant, however, a potential drawback is bleed-out after image formation because the surfactant does not cross-link. It is therefore preferred to use a copolymerizable monomer having surface-active effects, for example, silicone-modified acrylates, silicone modified methacrylates, fluorinated acrylates, and fluorinated methacrylates.

### Colorants

Colorants may be dyes or pigments or a combination thereof. Organic and/or inorganic pigments may be used. Suitable dyes include direct dyes, acidic dyes, basic dyes and reactive dyes. Suitable pigments are disclosed in EP-A 1637926 paragraphs [0098] [0100].

The pigment is present in the range of 0.01 to 10 wt %, preferably in the range of 0.1 to 5 wt %, each based on the total weight of curable fluid.

Solvents

The curable fluid preferably does not contain an evaporable component, but sometimes, it can be advantageous to incorporate an extremely small amount of a solvent to improve adhesion to the ink-receiver surface after UV curing. In this case, the added solvent may be any amount in the range of 0.1 to 10.0 wt %, preferably in the range of 0.1 to 5.0 wt %, each based on the total weight of curable fluid.

Humectants

When a solvent is used in the curable liquid, a humectant may be added to prevent the clogging of the nozzle, due to its ability to slow down the evaporation rate of curable fluid.

Suitable humectants are disclosed in EP-A 1637926 paragraph [0105]. A humectant is preferably added to the curable jettable liquid formulation in an amount of 0.01 to 20 wt % of the formulation, more preferably in an amount of 0.1 to 10 wt % of the formulation.

### Biocides

Suitable biocides include sodium dihydroacetate, 2-phenoxyethanol, sodium benzoate, sodium pyridinethion-1-oxide, ethyl p-hydroxy-benzoate and 1,2-benzisothiazolin-3-one and salts thereof. A preferred biocide is Proxel® GXL available from ZENECA COLOURS.

A biocide is preferably added in an amount of 0.001 to 3 wt %, more preferably in an amount of 0.01 to 1.00 wt %, each based on the total weight of the curable fluid.

### Preparation of a Curable Jettable Fluid

The curable fluids may be prepared as known in the art by mixing or dispersing the ingredients together, optionally followed by milling, as described for example in EP-A 1637322 paragraph [0108] and [0109].

### Viscosity of the Curable Fluids

The curable fluids have a viscosity at jetting temperature of less than 15 mPa·s, preferably of less than 12 mPa·s and more preferably of less than 10 mPa·s.

### Apparatus for Creating the Flexographic Printing Master

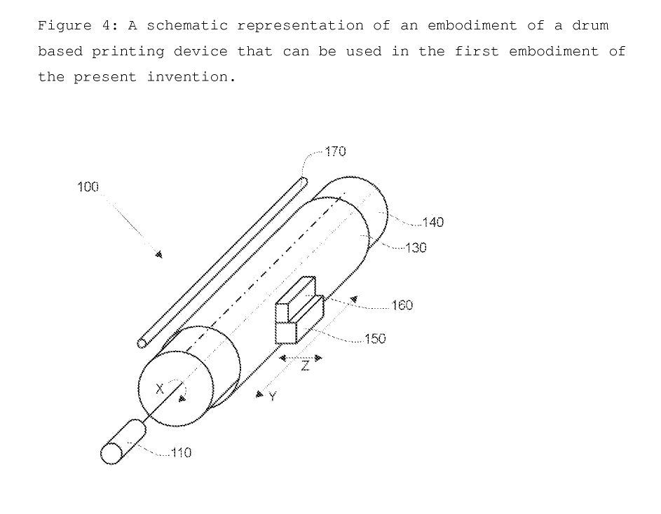

A particularly preferred drum based printing device (100) using a sleeve body as flexographic support to be used in the first preferred embodiment of the invention is shown in FIG. 4.

The sleeve body 130 is mounted on a drum 140. The drum 140 rotates in at a certain speed in the X-direction around axis 110. A printing device 160 moves in the Y-direction. A curing device (150) may be arranged in combination with the printing device, travelling therewith so that the curable fluid is exposed to curing radiation very shortly after been jetted. It may be difficult to provide a small enough radiation source connected to and travelling with the printing device. Therefore, a static fixed radiation source may be employed, e.g. a source of UV-light, which is then connected to the printing device by a flexible radiation conductor such as a fibre optic bundle or an internally reflective flexible tube.

Alternatively, a source of radiation arranged not to move with the printing device, may be an elongated radiation source extending transversely across the flexographic printing support surface to be cured and parallel with the slow scan direction of the print head (curing device 170). With such an arrangement, each applied fluid droplet is cured when it passes beneath the curing device 170. The time between jetting and curing depends on the distance between the printhead and the curing device 170 and the rotational speed of the rotating drum 140.

A combination of both curing devices 150 and 170 can also be used as depicted in FIG. 4.

### Printing Device

For inkjet printing, conventional print heads may be used.

The inkjet printer includes any device capable of coating a surface by breaking up a radiation curable fluid into small droplets which are then directed onto the surface. In the most preferred embodiment the radiation curable fluids are jetted by one or more printing heads ejecting small droplets in a controlled manner through nozzles onto a flexographic printing support, which is moving relative to the printing head(s). A preferred printing head for the inkjet printing system is a piezoelectric head. Piezoelectric inkjet printing is based on the movement of a piezoelectric ceramic transducer when a voltage is applied thereto. The application of a voltage changes the shape of the piezoelectric ceramic transducer in the printing head creating a void, which is then filled with radiation curable fluid. When the voltage is again removed, the ceramic returns to its original shape, ejecting a drop of fluid from the print head. However the inkjet printing method is not restricted to piezoelectric inkjet printing. Other inkjet printing heads can be used and include various types, such as a continuous type and thermal, electrostatic and acoustic drop on demand types. At high printing speeds, the radiation curable fluids must be ejected readily from the printing heads, which puts a number of constraints on the physical properties of the fluid, e.g. a low viscosity at the jetting temperature, which may vary from 25° C. to 110° C. and a surface energy such that the printing head nozzle can form the necessary small droplets.

An example of a printhead according to the current invention is capable to eject droplets having a volume between 0.1 and 100 picoliter (pl) and preferably between 1 and 30 pl. Even more preferably the droplet volume is in a range between 1 pl and 8 pl. Even more preferably the droplet volume is only 2 or 3 pl.

EP-A's 2420382, 2420383, 2465678 and 2371541 disclose preferred constellations of multiple print heads, preferably back to back print heads.

The resolution of the printhead constellation is higher than 300 dpi, preferably higher than 600 dpi, more preferably higher than 1200 dpi.

The mesa relief, the image relief and optional the elastomeric floor demand different quality and fluid properties, so preferably a different printhead constellation is used for jetting the mesa relief compared to the one used for jetting the image relief and/or elastomeric floor. Preferably the print-resolution of the printhead constellation for jetting the image relief is higher than the resolution of the print-head constellation for jetting the mesa relief, more preferably the ratio between the resolution of the print-head constellation for jetting the image relief and the resolution of the print-head constellation for jetting the mesa relief is an integer number higher than 1.

Preferably also a different fluid is used for jetting the mesa relief and jetting the image relief and/or elastomeric floor.

A shuttle holds the print head constellation in head positioning devices, preferably in a staggered fashion and shuttle fluid supplies for the fluid of the mesa relief, image relief and optional for the elastomeric floor.

The shuttle arranges the positioning of the head positioning devices to correct for each print head the distance between the print head and the diameter of the loaded sleeve.

The head positioning device aligns its print heads parallel to the axis of the mandrel and aligns a nozzle preferably the first nozzle of a first print head in the head positioning device to a fixed offset from a nozzle preferably the first nozzle of a second print head in the head positioning device. A head positioning device also aligns the nozzles of its print heads from the nozzles of print heads from another head positioning device.

A shuttle frame connects the shuttle to the base frame of the printing device. It supports accuracy less than 15 μm, preferably less than 8 μm, more preferably less 4 um in all positions from the shuttle to the mandrel by comprising preferably a high resolution encoder system and preferably a linear magnetic motor. The shuttle can be moved away from the sleeve to a maintenance purge position to inspect and service the shuttle.

The shuttle fluid supply supplies a fluid to the print heads in optimized conditions for jetting. The shuttle fluid supply comprises preferably a degassing unit to filter the fluid and degas the fluid below 40% and preferably a manifold wherein a static is adjusted so the nozzle column in a print head is under optimal conditions which depends on the level in the manifold and the nozzle plate of the print head. The shuttle fluid supply comprises preferably a valve to prevent a print head from leaking or sucking air into the nozzles of the print head.

The degassing unit comprises a degassing pump for the circulation of the fluid and a filter to prevent contamination of a print head and a degasser that pulls air out the fluid preferably through a membrane that is put in less than −500 mBar vacuum, preferably less than −800 mBar vacuum. The vacuum in the shuttle fluid supply is regulated preferably by a electro-pneumatic vacuum regulator.

### Curing

Typically for each layer of the relief image, immediately after the deposition of a fluid droplet by the printing device the fluid droplet is exposed by a curing source. This provides immobilization and prevents the droplets to run out, which would deteriorate the quality of the print master. Such curing of applied fluid drops is often referred to as “pinning”.

Curing can be “partial” or “full”. The terms “partial curing” and “full curing” refer to the degree of curing, i.e. the percentage of converted functional groups, and may be determined by, for example, RT-FTIR (Real-Time Fourier Transform Infra-Red Spectroscopy) which is a method well known to the one skilled in the art of curable formulations. Partial curing is defined as a degree of curing wherein at least 5%, preferably 10%, of the functional groups in the coated formulation or the fluid droplet is converted. Full curing is defined as a degree of curing wherein the increase in the percentage of converted functional groups with increased exposure to radiation (time and/or dose) is negligible. Full curing corresponds with a conversion percentage that is within 10%, preferably 5%, from the maximum conversion percentage. The maximum conversion percentage is typically determined by the horizontal asymptote in a graph representing the percentage conversion versus curing energy or curing time. When in the present application the term “no curing” is used, this means that less than 5%, preferably less than 2.5%, most preferably less than 1%, of the functional groups in the coated formulation or the fluid droplet are converted. In a method according to the present invention, applied fluid droplets which are not cured are allowed to spread or coalesce with adjacent applied fluid droplets.

Curing may be performed by heating (thermal curing), by exposing to actinic radiation (e.g. UV curing) or by electron beam curing.

Preferably the curing process is performed by UV radiation.

The curing device may be arranged in combination with the printing device, travelling therewith so that the curable fluid is exposed to curing radiation very shortly after been jetted (curing device 150, printing device 160). It may be difficult to provide a small enough radiation source connected to and travelling with the printing device. Therefore, a static fixed radiation source may be employed, e.g. a source of UV-light, which is then connected to the printing device by a flexible radiation conductor such as a fibre optic bundle or an internally reflective flexible tube.

Alternatively, a source of radiation arranged not to move with the printing device, may be an elongated radiation source extending transversely across the flexographic printing support surface to be cured and parallel with the slow scan direction of the print head (curing device 170). With such an arrangement, each applied fluid droplet is cured when it passes beneath the curing device 170. The time between jetting and curing depends on the distance between the printing device and the curing device 170 and the rotational speed of the rotating drum 140.

A combination of both curing devices 150 and 170 can also be used as depicted in FIG. 4.

Any UV light source, as long as part of the emitted light can be absorbed by the photo-initiator or photo-initiator system of the fluid droplets, may be employed as a radiation source, such as, a high or low pressure mercury lamp, a cold cathode tube, a black light, an ultraviolet LED, an ultraviolet laser, and a flash light.

For curing the inkjet printed radiation curable fluid, the imaging apparatus preferably has a plurality of UV light emitting diodes. The advantage of using UV LEDs is that it allows a more compact design of the imaging apparatus.

UV radiation is generally classified as UV-A, UV-B, and UV-C as follows:
UV-A: 400 nm to 320 nm
UV-B: 320 nm to 290 nm
UV-C: 290 nm to 100 nm

The most important parameters when selecting a curing source are the spectrum and the intensity of the UV-light. Both parameters affect the speed of the curing. Short wavelength UV radiation, such as UV-C radiation, has poor penetration capabilities and enables to cure droplets primarily on the outside. A typical UV-C light source is low pressure mercury vapour electrical discharge bulb. Such a source has a small spectral distribution of energy, with only a strong peak in the short wavelength region of the UV spectrum.

Long wavelength UV radiation, such as UV-A radiation, has better penetration properties. A typical UV-A source is a medium or high pressure mercury vapour electrical discharge bulb. Recently UV-LEDs have become commercially available which also emit in the UV-A spectrum and that have the potential to replace gas discharge bulb UV sources. By doping the mercury gas in the discharge bulb with iron or gallium, an emission can be obtained that covers both the UV-A and UV-C spectrum. The intensity of a curing source has a direct effect on curing speed. A high intensity results in higher curing speeds.

The curing speed should be sufficiently high to avoid oxygen inhibition of free radicals that propagate during curing. Such inhibition not only decreases curing speed, but also negatively affects the conversion ratio of monomer into polymer. To minimize such oxygen inhibition, the imaging apparatus preferably includes one or more oxygen depletion units. The oxygen depletion units place a blanket of nitrogen or other relatively inert gas (e.g. CO₂), with adjustable position and adjustable inert gas concentration, in order to reduce the oxygen concentration in the curing environment. Residual oxygen levels are usually maintained as low as 200 ppm, but are generally in the range of 200 ppm to 1200 ppm.

Another way to prevent oxygen inhibition is the performance of a low intensity pre-exposure before the actual curing.

A partially cured fluid droplet is solidified but still contains residual monomer. This approach improves the adhesion properties between the layers that are subsequently printed on top of each other. Partial intermediate curing is possible with UV-C radiation, UV-A radiation or with broad spectrum UV radiation. As mentioned above, UV-C radiation cures the outer skin of a fluid droplet and therefore a UV-C partially cured fluid droplet will have a reduced availability of monomer in the outer skin and this negatively affects the adhesion between neighbouring layers of the relief image. It is therefore preferred to perform the partial curing with UV-A radiation.

A final post curing however is often realized with UV-C light or with broad spectrum UV light. Final curing with UV-C light has the property that the outside skin of the print master is fully hardened.

Preferably the printing device comprises an UV shuttle with an UV LED bar to cure the layers of the mesa relief, image relief and optional the elastomeric floor. The UV shuttle follows the movement of the shuttle that comprises the print heads in longitudinal direction of the mandrel.

To prevent UV light from reaching the nozzle plates preferably anti-scattering profiles are installed in the UV shuttle parallel to the UV Led bar and preferably tangential to the circumference of the loaded sleeve. Through the anti-scattering profiles preferably some channels are foreseen to spray a thin layer of an inherent gas preferably N2 over the sleeve surface to improve the curing process.

To prevent the warming up of the sleeve or bridge sleeve preferably an air-knife is added to the UV Shuttle that sprays compressed air directly to the surface of the sleeve or bridge sleeve.

The UV LED bar comprises 1 or more UV LED modules which comprises one or more LED tiles which can be controlled separately. Preferably a linear guide mechanism in line with the diameter of the mandrel allows the UV LED modules are positioned less than 10 mm from the sleeve.

### EXAMPLES

All materials used in the examples were readily available from standard sources such as Aldrich Chemical Co. (Belgium) and Acros (Belgium) unless otherwise specified.
Laromer TBCH is a 4-t.butyl cyclohexyl acrylate from BASF
Miramer M202 is a 1,6 hexanediol (ethoxylated)diacrylate from MIWON.
Agfarad is a mixture of 4 wt % p-methoxyphenol, 10 wt % 2,6-di-tert-butyl-4-methylfenol and 3.6 wt % Aluminium N-nitroso-phenylhydroxylamine (available from CUPFERRON AL) in DPGDA.
Sartomer SR340, a 2-phenoxyethyl methacrylate from SARTOMER.
SR531, a cyclic trimethylolpropane formal acrylate from SARTOMER.
Sartomer CD 278, a monofunctional acrylate ester from SARTOMER.
CN435, an ethoxylated trimethylolpropane triacrylate from SARTOMER.
Irgacure 819 is a UV-photoinitiator from CIBA.
Lucirin TPO L, a UV-photoinitiator from BASF
EFKA 3600N, a levelling agent from BASF.
Poval 103, a polyvinylalcohol from Kururay.
Akypo OP80 is a surfactant from CHEMY.
Levasil 200E is a silica dispersion from Bayer.
Sunspere H51, a silica powder from Asahi Glass.
Satintone 5, a filler from BASF.
PEDOT/PSS, a PEDOT/PSS dispersion from Agfa Gevaert.
Chemguard S-550, a surfactant from Chemguard.
Kieselsol 100F, a silica from Bayer.
Polygen WE7, a PE latex from BASF.
PMMA, a polymethylmethacrylate latex from Agfa Gevaert.
Dowfax 2A1, a surfactant from Dow Chemicals.
Servoxyl VPDZ3, a surfactant from Servo Delden BV.
Surfynol 420, a surfactant from Air Products.
Hydrorez 1200 D, a sulfopolyester latex from Lawter.
Parez Resin 613, a melamine-formaldehyde resin from Cytec.
Copol (ViC12-MA-IA), a copolymer of vinylidenechloride-methacrylic acid and itaconic acid; from Agfa Gevaert.
Mersolat H40, a surfactant from Lanxess.
Arkopon T, a surfactant from Hoechst.
Copol(Butadiene-IA-MMA), a copolymer of butadiene-itaconic acid-mehtylmethacrylic.
Ultravon W, a surfactant from Ciba-Geigy
Hydran AP20, a polyester polyurethane dispersion from Dainippon Ink.
Hydran AP40N, a polyester polyurethane dispersion from Dainippon Ink.
PMMA matting agent, a polymethylmethacrylate matting agent, particle size=750-1200 nm.

### Example 1

In this example, the influence of a primer on a PET support has been investigated.

Different primers have been investigated on PET regarding their adhesion towards the relief image.

In a first experiment, a curable composition having a composition as indicated in Table 1 was coated at a thickness of 290 μm on a primed PET (thickness=100 μm) and cured for 2 minutes under UV-A light (light box equipped with 8 Philips TL 20 W/10 UVA (λₘₐₓ=370 nm) lamps; the distance between the sample and the lamps was ±10 cm) and for 20 minutes under UV-C light (light box equipped with 4 Philips TUV lamps (λₘₐₓ=254 nm). The same experiment has been carried out on a PET without primer. Both UV-A and UV-C exposure were carried out in an inert atmosphere (The light box was filled with N₂).

TABLE 1

| Ingredients | Amount (g) |
|---|---|
| Laromer TBCH | 23.00 |
| Miramer M202 | 9.24 |
| Sartomer SR340 | 13.85 |
| Phenoxyethylacrylate | 13.85 |
| Sartomer 531 | 13.21 |
| Sartomer CD 278 | 2.31 |
| CN435 | 11.54 |
| Agfarad | 0.70 |
| Irgacure 819 | 6.00 |
| Lucirin TPO L | 6.00 |
| EFKA 3600N | 0.30 |

The primed PET supports were prepared by coating different primers P-01 to P-08 on a PET support having a thickness of 100 μm.

### Primer P-01

P-01 was coated from an aqueous coating solution having a pH of 3.5 and a viscosity of 3-5 cP (measured at 45° C.). The dry coating weight of P-01 is shown in Table 2

TABLE 2

| P-01 | mg/m² |
|---|---|
| Poval 103 | 2114 |
| Akypo OP80 | 52.78 |
| Levasil200E | 3168.9 |
| Sunspere H51 | 31.64 |
| Satintone5 | 106.1 |
| Servoxyl VPDZ3 | 75.3 |

### Primer P-02

P-02 was coated from an aqueous coating solution having a pH of 6.5 and a viscosity of 1.65 mPas (measured at 45° C.). The dry coating weight of P-02 is shown in Table 3.

TABLE 3

| P-02 | mg/m² |
|---|---|
| Keltrol RD | 10 |
| PEDOT/PSS | 12 |
| Chemguard S-550 | 0.63 |
| Kieselsol 100F | 20 |
| Polygen WE7 | 0.30 |
| PMMA | 1000 |
| Sunspere H51 | 30 |

### Primer P-03

P-03 was coated from an aqueous coating solution having a pH of 6.5. The dry coating weight of P-03 is shown in Table 4.

TABLE 4

| P-03 | mg/m² |
|---|---|
| Dowfax 2A1 | 0.65 |
| Surfynol 420 | 0.65 |
| Hydrorez 1200 D | 36.6 |
| Hordamer PEO2 | 0.44 |
| Parez Resin 613 | 3.38 |

### Primers P-04 to P-07

P-04 to P-07 were coated from an aqueous coating solution. The dry coating weights are shown in Table 5.

TABLE 5

| Ingredients (mg/m²) | P-04 | P-05 | P-06 | P-07 |
|---|---|---|---|---|
| PEDOT/PSS | 2.430 | — | 2.830 | — |
| Copol (ViCl₂-MA-IA) | 113.500 | 113.000 | 381.600 | 113.00 |
| Kieselsol 100F | 12.200 | 26.500 | 80.700 | 26.500 |
| Mersolat H40 | 0.283 | 1.440 | — | 0.750 |
| Arkopon T | — | 2.800 | — | — |
| Copol (Butadiene-IA-MMA) | — | — | 45.200 | — |
| Ultravon W | — | — | — | 4.00 |

### Primer P-08

P-08 was coated from an aqueous coating solution. The dry coating weights are shown in Table 6.

TABLE 6

| | mg/m² |
|---|---|
| Hydran AP20 | 101.800 |
| Hydran AP40N | 101.500 |
| Parez Resin 613 | 8.100 |
| Dowfax2A1 | 1.100 |
| Surfynol 420 | 1.100 |
| PMMA matting agent | 1.700 |

The adhesion has been evaluated by the manual peel test and the cross cut test.

In the manual peel test, the detachability of the cured layer from its PET support is checked with a sharp knife. A rating from 0 to 5 has been given to the samples wherein rating 0 means that the cured layer was unable to detach from the support, while a rating 5 means that the layer was very easily detached from the support.

The results are given in Table 7.

TABLE 7

| Primer | binder | Peel test |
|---|---|---|
| No | | 5 |
| primer | | |
| P-01 | Copol (vinylacetate-vinylalchol) | 3 |
| P-02 | pMMA | 3 |
| P-03 | Sulfonated polyester | 2 |
| P-04 | Copol (vinylidenechloride-methylacrylate | 2 |
| | acid-itaconic acid) | |
| P-05 | Copol (vinylidenechloride-methylacrylate | 3 |
| | acid-itaconic acid) | |
| P-06 | Copol (vinylidenechloride-methylacrylate | 3 |
| | acid-itaconic acid) | |
| P-07 | Copol (vinylidenechloride-methylacrylate | 3 |
| | acid-itaconic acid) | |
| P-08 | Polyester polyurethane | 3 |

It is clear from Table 7 that the adhesion of the relief image to the PET support improves substantially when a primer is applied to the PET support.

In a second experiment, multiple layers of the curable fluid of Table 2 have been jetted using a CA4 print head from Toshiba Tec in multidrop mode to obtain drop volumes of 42 pL on a cylindrical drum and cured. The drum speed was 300 m/s, the head driving voltage 23 V, the resolution 300 dpi and the firing frequency 24.8 kHz. 90 layers were instantly partially cured with LED (60% LED-output 395 nm, the LEDs used were the 2UVM124 type LEDsfrom Baldwin), 10 layers were delayed cured (120 seconds after jetting) with UV-A light (light box equipped with 8 Philips TL 20 W/10 UVA (λₘₐₓ=370 nm) lamps; the distance between the sample and the lamps was ±10 cm).

The total thickness of the relief image was 300 μm.

The same adhesion tests as described above were carried out, the results of which are shown in Table 8.

TABLE 8

| Primer | Peel test |
|---|---|
| No primer | 5 |
| P01 | 3 |
| P02 | 4 |
| P03 | 2 |
| P04 | 3 |
| P05 | 2 |
| P06 | 3 |
| P07 | 3 |
| P08 | 2 |

The results shown in Table 7 and 8 clearly indicate that a primer improves the adhesion between the PET support and the relief image. In addition, these results also indicate that different primers give different adhesion results. Preferred primers have as binder: a sulfonated polyester, a copolymer of vinylidene chloride-methacrylic acid-itaconic acid, and a polyester polyurethane.

### Example 2

In this example different Twinlock self adhesive sleeves from Polymount International BV are used in a method of the present invention.

Three sleeves have been tested, each having a different compressibility due to different resilient layers used.

The static compression, together with the creep recovery of these three Twinlock sleeves is shown in Table 9.

TABLE 9

| | Compression | | Thickness |
|---|---|---|---|
| | (%) | Creep recovery (%) | (mm) |
| Twinlock White | 12.19 | 75.32 | 1.945 |
| Twinlock Blue | 11.28 | 76.11 | 2.069 |
| Twinlock Black | 8.20 | 76.58 | 2.303 |

The static compression referred to Table 1 has been measured with a ball point probe (2.7 mm) where the sample is “compressed” for 5 minutes with a fixed pressure of 0.005 MPa.

After release of the pressure, the creep recovery, after 1.2 and 15 seconds, has been measured.

It is clear from Table 9 that all Twinlock sleeves have a similar and sufficient resilience.

Flexographic printing masters were made based on a 2D image which contains solid image elements and single dots reproducing a 1 pixel dot at 1200 dpi and an interdot distance of 10 pixels. The support was fixed on the drum of a printing device via a double sided tape. Ink jet heads (CA5 heads from Toshiba Tec) were placed at the top of the drum and a bar containing UV LED's, emitting at 395 nm, was placed behind the Ink jet heads so that the drops, when jetted on the rotating drum (500 mm/s) will be immediately cured. The flexographic printing master was produced by consecutively jetting, a UV curable fluid (the same fluid as in Example 1, see Table 1 for the composition) followed by a curing with UV light. The 3D image was hence build layer after layer. The thickness of one layer is approximately 6 μm. Samples were prepared consisting of 26 or 48 layers.

After jetting and curing the complete 3D image, the samples, containing the PET support and the 3D image, were removed from the drum of the printing device. The samples were then fixed on an impression cylinder which contains the Twinlock sleeve. The impression cylinder makes part of a Gallus RCS430 press. The Anilox volume has an ink amount of 3.5 g/m, the ink used was the Ink Flexocure Force Cyan (from Flint Group), and the substrate to be printed was a polypropylene foil (Ryoface) of 90 μm.

The evaluation of the image quality of the solid images was done visually, especially the presence of a line structure which is mostly related to the ink jetting process, was looked at. The line structure in solid areas is probably the result of the coalescence of jetted drops in the fast scan direction. From the printing tests it was observed that, the solid images do show a lower level of the line structure the harder the foam, i.e. the resilient layer, of the Twinlock sleeve was. The image quality of the single 1 pixel dots was evaluated by measuring the ratio of the missing dots on print (missing dots are dots which did not lead to ink transfer) to the total number of dots on the flexographic printing master of the image patch. From the printing tests it was observed that the ratio of the missing dots was decreasing with increasing hardness of the foam, i.e. the resilient layer, of the Twinlock sleeve.

### Example 3

In this example, supports with a different thickness have been investigated in a method of the present invention.

Different PET supports having a different thickness have been investigated: 23-100 and 175 μm.

A 3D image was formed on the different PET supports, as described in EXAMPLE 2.

From the printing tests it was observed that, the solid images do show a lower level of the line structure the thicker the PET support was. From the printing tests it was also observed that the ratio of the missing dots was decreasing with increasing thickness of the PET support.

1-13. (canceled)

14. A method for preparing a flexographic printing master, the method comprising the steps of:
providing a sleeve including a resilient layer and a self adhesive on an outer surface of the sleeve;
providing a support on the self adhesive; and
forming a relief image on the support by applying and curing a curable fluid.

15. The method according to claim 14, wherein the sleeve includes, in this order, a basic sleeve, the resilient layer, a dimensionally stable supporting layer, and the self adhesive.

16. The method according to claim 14, wherein the support includes a primer upon which the relief image is formed.

17. The method according to claim 14, wherein the resilient layer has a static compression, measured with a ball point probe with a diameter of 2.7 mm and a sample of the resilient layer is deformed for 5 minutes with a fixed pressure of 0.005 MPa, of less than 8.5%.

18. The method according to claim 14, wherein the resilient layer includes a polyurethane foam.

19. The method according to claim 16, wherein the primer contains a binder selected from a sulfonated polyester, a polyester polyurethane, and a copolymer of vinylidenechloride-methacrylic acid-itaconic acid.

20. The method according to claim 18, wherein the primer contains a binder selected from a sulfonated polyester, a polyester polyurethane, and a copolymer of vinylidenechloride-methacrylic acid-itaconic acid.

21. The method according to claim 14, wherein the support is a PET support having a thickness of at least 150 μm.

22. The method according to claim 14, wherein the relief image includes a mesa relief and an image relief.

23. A method of printing comprising the steps of:
providing a sleeve including a resilient layer and a self adhesive on an outer surface of the sleeve;
providing a support on the self adhesive;
forming a relief image on the support by applying and curing a curable fluid;
applying a flexographic ink to the relief image; and
transferring the ink from the relief image to a receiver material.

24. The method for preparing a flexographic printing master according to claim 14, further comprising the steps of:
applying a flexographic ink to the relief image;
transferring the ink from the relief image to a receiver material;
removing the support including the relief image from the sleeve;
optionally cleaning the outer surface of the sleeve;
providing a new support on the outer surface of the sleeve; and
forming a new relief image on the new support by applying and curing a curable fluid.

25. A method for preparing a flexographic printing master, the method comprising the steps of:
providing a sleeve including a resilient layer and a self adhesive on an outer surface of the sleeve;
providing a direct laser engraving flexographic printing master precursor on the self adhesive; and
forming a relief image by direct laser engraving the flexographic printing master precursor.

26. A method of printing comprising the steps of:
providing a sleeve including a resilient layer and a self adhesive on an outer surface of the sleeve;
providing a direct laser engraving flexographic printing master precursor on the self adhesive;
forming a relief image by direct laser engraving the flexographic printing master precursor;
optionally carrying out a cleaning step;
applying a flexographic ink to the relief image; and
transferring the ink from the relief image to a receiver material.

27. The method for preparing a flexographic printing master according to claim 25, further comprising the steps of:
applying a flexographic ink to the relief image;
transferring the ink from the relief image to a receiver material;
removing the flexographic printing master;
optionally cleaning the outer surface of the self adhesive;
providing a new direct laser engraving flexographic printing master precursor on the self adhesive; and
forming a new relief image by direct laser engraving the flexographic printing master precursor.
